(19) United States
(12) Patent Application Publication
(10) Pub. No.: US 2026/0073121 A1
(43) Pub. Date: Mar. 12, 2026

(54) SYSTEMS AND METHODS FOR AUTOMATED MESSAGING MANAGEMENT

(71) Applicant: YAHOO ASSETS LLC, New York, NY (US)

(72) Inventors: Sanika SHIRWADKAR, Milpitas, CA (US); Rofaida ABDELAAL, Sunnyvale, CA (US); Vignesh GANAPATHIRAMAN, Bothell, WA (US); Bhopal SINGH, San Jose, CA (US); Kenneth SEBASTIAN, Danville, CA (US)

(21) Appl. No.: 18/826,271

(22) Filed: Sep. 6, 2024

(51) Int. Cl. G06F 40/166; G06F 40/20; H04L 51/42

(52) U.S. Cl. CPC G06F 40/166; G06F 40/20; H04L 51/42

(57) ABSTRACT

Disclosed are systems and methods that provide a decision-intelligence (DI)-based, computerized framework for determining and implementing the mechanisms for compiling and/or displaying a summary of an electronic message within an inbox. The disclosed framework provides novel mechanisms for triaging messaging, in that mechanism for how they are pre-, post- and/or in real-time processed by the server, sender and/or recipient devices pursuant to providing summarizations for an improved user consumption experience. The framework operates to determine which messages are candidates for specific forms of triaging, then queues such messages for summarization according to the mechanism for which it will be delivered. Such determination and summarization can effectuate an improved messaging experience as it relates to how messages are handled by inboxes and/or displayed for interaction by recipient users.

### FIELD OF THE DISCLOSURE

The present disclosure relates to electronic messaging, and more particularly, to a decision intelligence (DI)-based computerized framework for determining and implementing the mechanisms for compiling and/or displaying a summary of an electronic message within an inbox.

### SUMMARY OF THE DISCLOSURE

By way of background, triaging an inbox is a notoriously tedious task for users, often involving sifting through a barrage of emails that range from critical work communications to spam and promotional messages. This process requires constant decision-making about what to prioritize, respond to, defer, delete, and the like. Such volume of emails can be overwhelming, leading to decision fatigue and a sense of frustration as users attempt to stay organized. Important emails can easily get buried under the weight of less relevant ones, necessitating meticulous scrutiny to ensure nothing crucial is missed. Additionally, managing email subscriptions, sorting through repetitive notifications, and dealing with follow-up reminders add to the complexity. The repetitive nature of these actions, combined with the cognitive load of categorizing and responding appropriately, makes inbox triaging a time-consuming and often exasperating task.

To that end, the disclosed systems and methods provide a novel computerized framework that operates on or in conjunction with inboxes of users to provide advanced capabilities that streamline the triaging process. According to some embodiments, as discussed herein in more detail, rather than requiring users to open messages to understand the context and/or information contained therein, via the advent of the disclosed technology, users are provided previously non-native functionality for viewing compiled summaries of the email content without having to open their emails.

The disclosed framework operates to determine which messages are candidates for specific forms of triaging (e.g., summarization), then queues such messages for summarization according to the mechanism for which it will be delivered. In some embodiments, for example, a message can be analyzed at the sender device, at the server, or on the recipient's device, or some combination thereof, for which a summarized email may be sent, generated and/or compiled at the recipient device. In some embodiments, as discussed herein, candidates for such specific forms of messaging triaging can be based on, but not limited to, a message type (or class, used interchangeably), sender identifier (ID), recipient ID, content, content type, age-appropriateness of the content (e.g., PG-13), a time, date, location of the recipient, and the like, or some combination thereof.

For example, when a user receives an email from a sender, the email contains information therein (e.g., in the message body, and subject line, information indicates what the email is about in relation to, and details related thereto). For example, the sender, the recipient's accountant, sends the recipient an email that indicates the documents they need to properly file their taxes. As in conventional systems, rather than simply displaying the sender's identity (ID), subject line and an email snippet (e.g., the first n characters of the email body that can fit within the message item within the inbox), the disclosed framework operates, for example, to feed the email information (e.g., message content and/or header information, for example) to a large language model (LLM) that can generate a summary of the email, which can be displayed within the message item displayed within the inbox listing. Thus, rather than having to open the email to view which documents are needed, the recipient can simply view the summary which can detail the documents needed/requested, saving keystrokes and processing time on the user device.

Accordingly, as discussed herein, summarizing electronic messages (e.g., emails) and displaying such summaries in a manner that enables users to garner relevant context and information from a message without having to open the message offers significant benefits both technologically and personally. For example, from a technical perspective, such functionality enhances the efficiency of email systems by reducing data storage and bandwidth requirements, as summarized emails take up less space and are quicker to transmit and display. This streamlined processing can lead to faster email delivery and display times, optimizing server performance and reducing operational costs. Additionally, automated summarization tools can integrate with spam filters and prioritization algorithms, improving the overall management and organization of emails.

Indeed, summarizing emails greatly enhances productivity and time management for users. For example, such functionality allows individuals to quickly grasp the essential information without wading through lengthy text, facilitating faster decision-making and response times. This is particularly beneficial in professional settings where prompt communication is crucial. Summarized emails can also reduce cognitive load and stress, as users can efficiently manage their inboxes and focus on more critical tasks.

Overall, as discussed and evident in the below discussion, email summarization for which the modified inbox display discussed herein is provided contributes to an improved organized, efficient, and less overwhelming email experience for users and the systems providing such email services.

According to some embodiments, a method is disclosed for a DI-based computerized framework for determining and implementing the mechanisms for compiling and/or displaying a summary of an electronic message within an inbox. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for determining and implementing the mechanisms for compiling and/or displaying a summary of an electronic message within an inbox.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

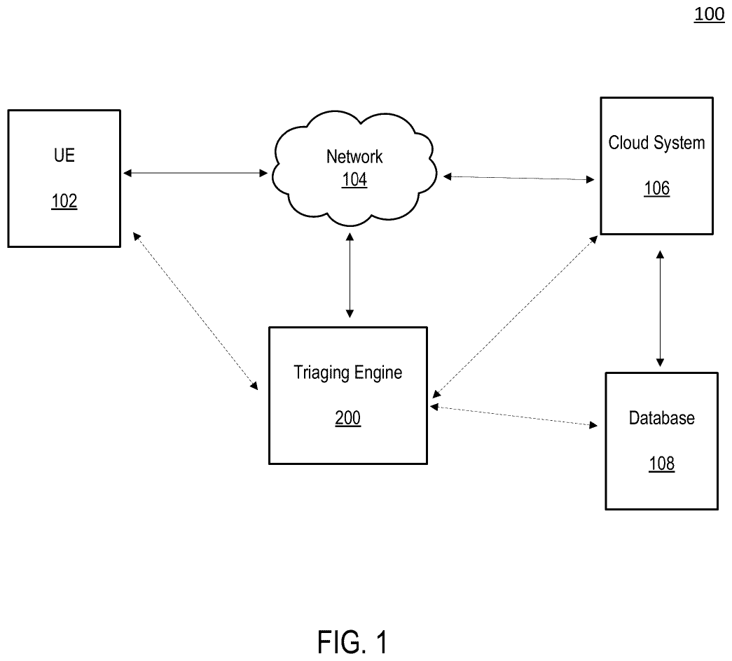

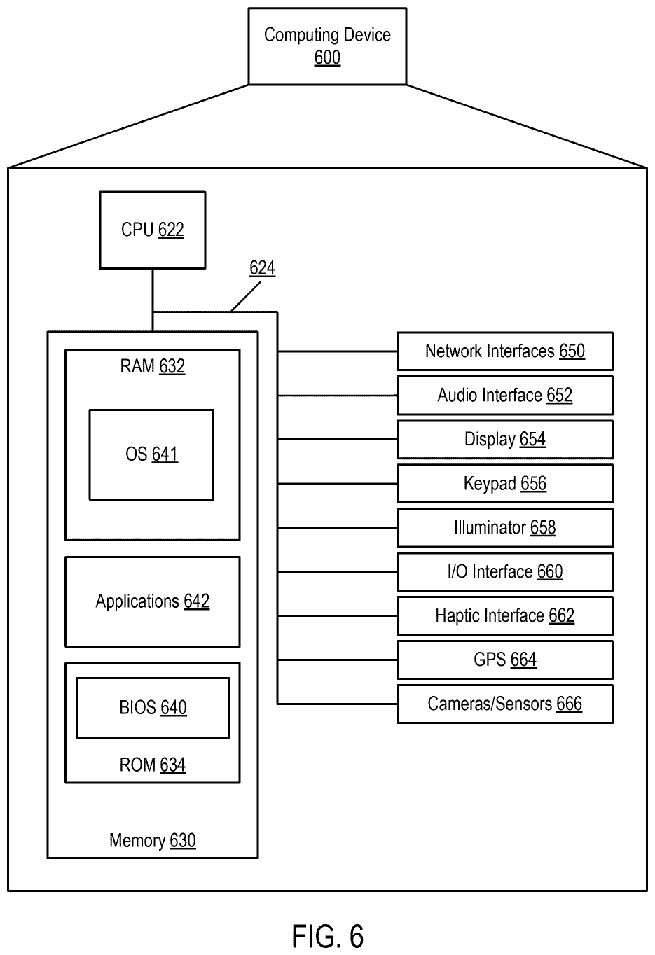

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and triaging engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or triaging engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

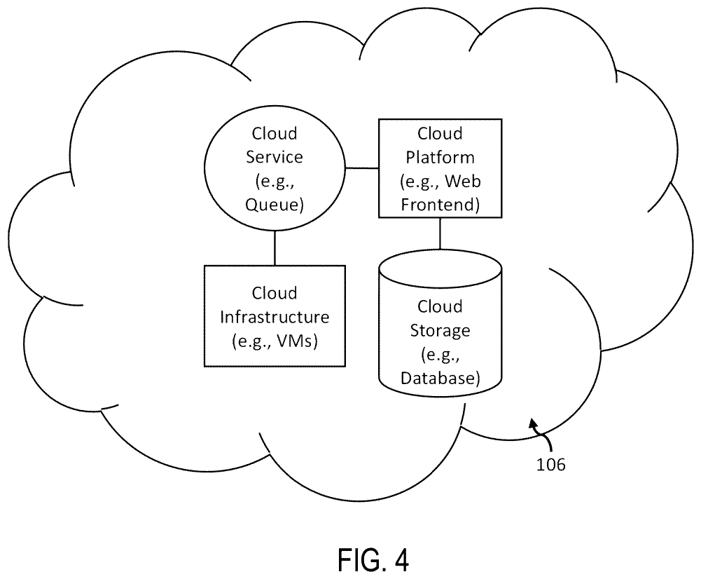

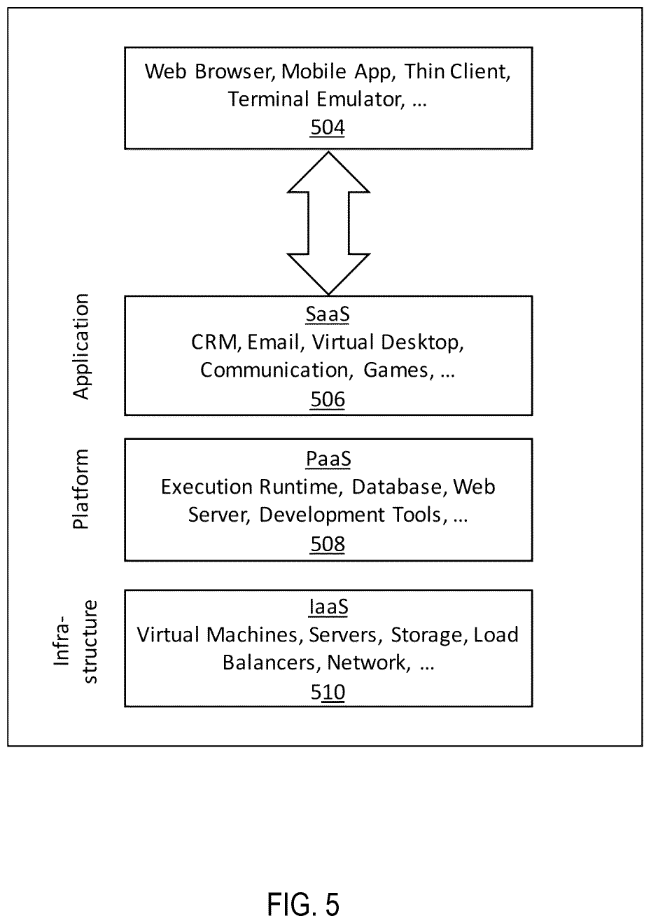

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Triaging engine 200, as discussed above and further below in more detail, can include components for the disclosed functionality. According to some embodiments, triaging engine 200 may be a special purpose machine or processor, and can be hosted by a device on network 104, within cloud system 106, and/or on UE 102. In some embodiments, engine 200 may be hosted by a server and/or set of servers associated with cloud system 106.

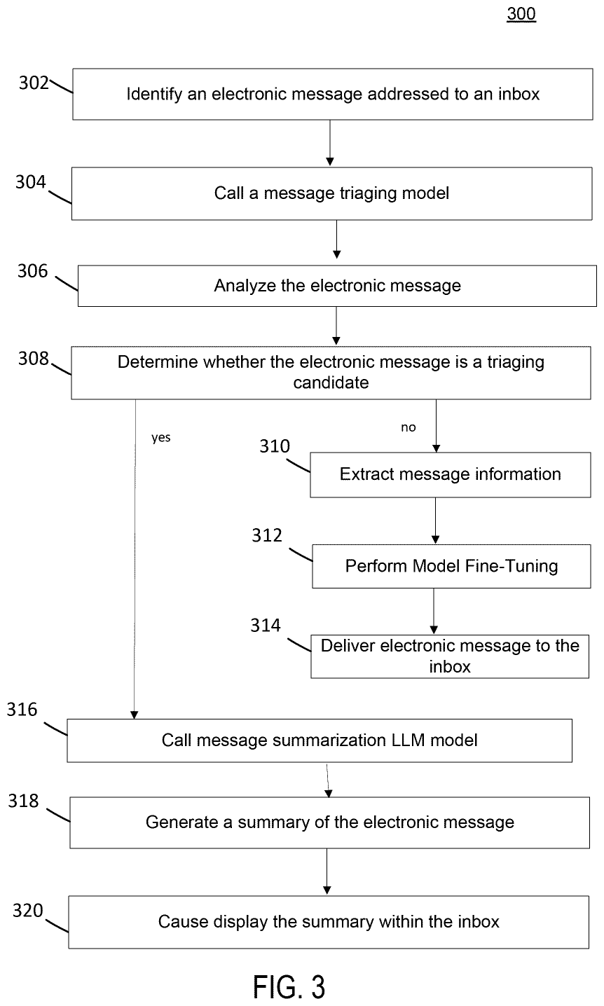

According to some embodiments, as discussed in more detail below, triaging engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, triaging engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

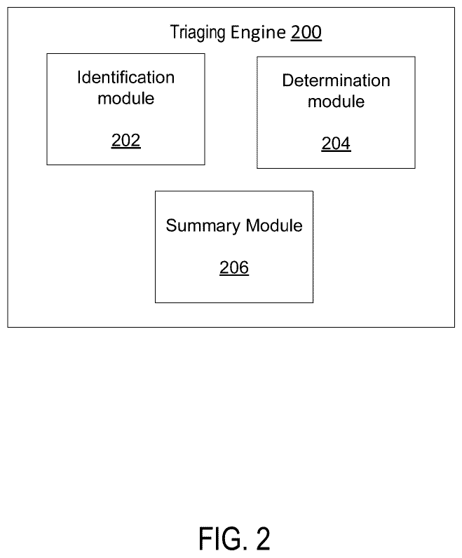

As illustrated in FIG. 2, according to some embodiments, triaging engine 200 includes identification module 202, determination module 204 and summary module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Triaging engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for determining and implementing mechanisms for compiling and/or displaying a summary of an electronic message within an inbox. As provided below, the disclosed framework's configuration and implementation can provide a computerized suite of tools for providing advancements in how electronic messages are handled pursuant to their display within a recipient's inbox, as well as how users can interact with such electronic messages.

According to some embodiments, Steps 302, 304 and 316 of Process 300 can be performed by identification module 202 of triaging engine 200; Steps 306-310 can be performed by determination module 204; and Steps 312, 314, 318 and 320 can be performed by summary module 206.

According to some embodiments, Process 300 begins with Step 302 where an electronic message addressed to an inbox of a user is identified. As discussed above, engine 200 can operate on a UE (e.g., sender and/or recipient device) and/or on a device on the network; therefore, in some embodiments, the identification of the message can be performed upon receiving input for transmittal at the sender device, at the server, and/or at the recipient device.

By way of example, the identified electronic message can correspond to sender X sending recipient Y an email. Thus, as per the above, in some embodiments, engine 200 can identify (e.g., receive) the message upon the server associated with the email service providing the inbox receiving the message, and prior to delivery to the inbox account of the user. And, in some other non-limiting example embodiments, engine 200 can identify the message via an application running on the recipient's device (e.g., a stand alone application, or application integrated with the mail application executing on the user's device, as discussed above).

Thus, as discussed herein, the disclosed operational steps of Process 300 can be performed at the cloud/network level, and/or at the user device level, without the need for cloud communication, as devices are now and in the future capable of running artificial intelligence (AI) applications in whole or in part without the need for cloud support.

In Step 304, engine 200 can operate to call a message triaging model. According to some embodiments, a message triaging model refers to an AI, machine learning (ML) and/or large language model (LLM) that operates to categorize (and/or prioritize) incoming electronic/digital communications, such as emails. In some embodiments, as discussed herein, when applied to classifying mail messages, the message triaging model can analyze the electronic message, inclusive of the content and metadata associated therewith, to, inter alia, sort messages into predefined categories, assign priority levels, and identify important or time-sensitive information. For example, as discussed below, the message triaging model can determine whether the message is a candidate for summarization (as per Steps 306-308, discussed infra).

Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, the message triaging model may be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

According to some embodiments, the message triaging model can be trained on data that enables and/or utilizes temporally restricted data. For example, labeled training data that has been curated and used to train the model within the past k time (e.g., 3 months). This can ensure accuracy in context, slang, seasonality basis, and the like.

In some embodiments, the message triaging model can be trained from n “qualifying” emails (e.g., emails that satisfy a criteria within the k months) from m inboxes (a threshold satisfying number of user inboxes, which can be global, or per region). For example, by sampling from a wide range of inboxes for training purposes, the message triaging model can be exposed to a more diverse set of writing styles, vocabulary and/or topics, which can improve how the model is tuned to better learn and generalize its knowledge to unseen emails, making it more robust and accurate. Indeed, sampling and training from fewer emails from each individual inbox would help reduce the risk of bias towards specific senders or communication patterns.

According to some embodiments, the message triaging model can be fine-tuned/trained based on a composite set of information that includes a sampling that is based on, but not limited to, frequency (number of emails per email class/type), importance (e.g., based on user actions per email class (e.g., open, dwell, and the like) and/or priority (e.g., product prioritization) of each email class, and a higher representation of underrepresented email classes. In some embodiments, for the sampling, a proportion of supplemental samples can be adjusted based on the frequency/importance/priority of each class (to be confirmed with the product), and the degree to which an imbalance can be mitigated (e.g., ensure that each class/type has y samples, which can void certain classes being ignored during fine-tuning.

In some embodiments, the message triage model can be trained based on two types of sets of training data: a set with production-like data distribution of each email class (or alternatively: a set that reflects the importance of each class); and/or a set with a balanced class distribution −Z randomly sampled emails per email class. For each set, there can be an equal number of instances from each class, irrespective of their production frequencies or importance or priority; and in some embodiments, if editorial resources are limited, one dataset can be prioritized over the other based on prioritization from a product.

Thus, the disclosed sampling and training based therefrom of the message triaging model can ensure that the model learns “true” production-like data distributions (e.g., class importance), is exposed to a threshold satisfying amount of email classes that may be sparser on certain platforms/domains and/or for certain users, and does not become over-biased towards overrepresented classes.

Continuing with Process 300, in Step 306, engine 200 can analyze the electronic message via the messaging triaging model. In some embodiments, the electronic message, and/or information extracted, determined, derived, compiled or otherwise identified from the electronic message can be fed as input to the message triaging model (from Step 304).

In Step 308, based on the analysis in Step 306, engine 200 can determine whether the electronic message is a triaging candidate. In some embodiments, messages that are capable of being classified can be based on, but not related to, sender ID, sender domain, content, category of content, type of content, number of recipients, recipient ID, message type, message format, a time, date, a location, and the like, or some combination thereof. For example, messages that, based on the above training, can be determined as triaging candidates can include, but are not limited to, messages with a specific urgency level (e.g., high, medium, low), business emails (e.g., sales, support, human resources (HR)), message types (e.g., inquiry, feedback), social or personal messages, invitations, and the like; and messages that may be determined as being a type, category or of a certain form that remove them from being a candidate can be, but are not limited to, explicit or X-rated content, illegal activities, emotional content, sarcasm, personal or sensitive information, and the like.

In some embodiments, when the electronic message is determined as not being a triaging candidate, processing can proceed from Step 308 to Step 310.

In Step 310, engine 200 can perform operations to extract message information from the electronic message, which can include, but is not limited to, data, metadata and/or content from the message—for example, sender ID, sender domain, content information, and the like. In some embodiments, such extraction can involve engine 200 parsing the electronic message, and extracting such information. In some embodiments, any of the above discussed AI, ML and/or LLM models can be utilized to parse and extract the information via Step 310. In some embodiments, operations related to Step 310 can be performed offline.

In Step 312, based on the extracted information and the decision from Step 308 (e.g., to not triage the message), engine 200 can perform model-fine tuning operations respective to the message triaging model. This can involve further training the message triaging model so as to more effectively, accurately and efficiently performing similar triaging decisions when presented with similar messages and/or messages with similar content. In some embodiments, operations related to Step 312 can be performed offline.

In Step 314, based on the determination in Step 308, engine 200 can cause the delivery of the electronic message in/to the inbox of the recipient. Such delivery occurs without modification of the message, and according to protocol of the messaging application/platform utilized to deliver such message (e.g., according to a delivery protocol defined by a message platform hosting the inbox).

Turning back to Step 308, when engine 200 determines that the electronic message is a candidate for triaging, processing can proceed from Step 308 to Step 316.

In Step 316, engine 200 can call a message summarization model. In some embodiments, the message summarization model can be an LLM which can perform operations to generate an NLP summary of the content associated with the electronic message. In some embodiments, the summary may be constricted to a number of characters proportionate to an amount of space available within a message inbox item that is capable of being displayed within an inbox of a user's messaging account display page.

According to some embodiments, by way of a non-limiting example, engine 200 can call a message summarization model as disclosed in co-owned U.S. Ser. No. 18/738,869, filed on Jun. 10, 2024, titled “Systems And Methods For A Modified Message Display Including A Compiled Summary Within An Unopened Message Item.” Thus, as provided below in Steps 318 and 320, such model can execute to perform steps for generation of a summary, a curated/customized title of the email and/or provide actions for the user to perform on a message (e.g., add to calendar, respond, delete, forward, and the like), as discussed below.

In Step 318, engine 200 can execute the message summarization model, whereby a summary of the electronic message is generated. For example, if the message is an invitation to a party on Jan. 1, 2025 for the recipient's nephew's birthday, the summary can state “Birthday party on Jan. 1, 2025 for baby Lucas; please RSVP.”

In some embodiments, upon generation of the summary for the electronic message, engine 200 can call and execute an AI/ML and/or LLM model. In some embodiments, such AI/ML and/or LLM model can be a separate model that can determine whether a context of the summary corresponds to or is similar (at least to a threshold) to a context of the content of the electronic message. Such analysis can be performed via any of the AI/ML and/or LLM models discussed above. In some embodiments, such AI/ML and/or LLM model can be a model used for the summarization and/or categorization, discussed supra.

Accordingly, as discussed above, Step 318 can involve, for example, summarizing an email for display within a recipient's inbox, thereby making it easier for the recipient to quickly grasp the main points without needing to open and read the full message. By generating a concise summary of the email content, the provided summary, as a message item displayed within the inbox, can highlight key information such as, but not limited to, the purpose, action items, and/or important updates. Such summary can be placed within the inbox as a message item, placed at the top of the email or in the subject line preview, and the like, thereby allowing the recipient to receive a quick overview at a glance, which can be provided without a need for the user to open the message in some embodiments. Moreover, such functionality provided via the generated (and provided, as per below in Step 320) can be particularly helpful by reducing time spent on scanning through long or detailed emails, improving productivity, and ensuring important details are not missed. Indeed, the disclosed functionality enables users to prioritize their emails efficiently, deciding which ones require immediate attention and which can be addressed later, thereby providing them with a streamlined way to manage their inbox.

And, in Step 320, engine 200 can cause the display of the summary within the inbox of the recipient. In some embodiments, the summary can be displayed as a new mail item in the inbox listing of the recipient user's inbox account. In some embodiments, the summary can be displayed as a mail item within another tab of the inbox interface (UI) and/or within a separate folder of the inbox; where, in some embodiments, the original message may be displayed.

Accordingly, the disclosed framework provides novel mechanisms for determining which messages are to be summarized, and based on this determination/classification, displaying messages in a modified manner that provides users with previously non-native functionality for viewing and/or interacting with content of received messages.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by an application, an electronic message addressed to an inbox of a recipient;
analyzing, by the application executing a messaging triaging model, the electronic message; and
determining, by the application, based on the analysis, whether the electronic message is a triaging candidate, the determination further comprising:
causing delivery of the electronic message to the inbox according to a delivery protocol defined by a message platform hosting the inbox when the application determines the electronic message is not a candidate for triaging, and
causing delivery of at least an email summary of the electronic message to the inbox when the application determines the electronic message is a candidate for triaging.

2. The method of claim 1, further comprising:
calling, upon identifying of the electronic message, the message triaging model.

3. The method of claim 1, further comprising:
sampling data from a set of electronic messages;
sampling data from a set of inboxes;
analyzing the sampled data from the set of electronic messages and the sampled data from the set of inboxes; and
performing fine-tuning of the message triaging model based on the analysis of the sampled data.

4. The method of claim 1, further comprising:
extracting message information from the electronic message; and
performing model-fine tuning of the message triaging model based on the electronic message and information related to the triaging determination.

5. The method of claim 1, further comprising:
calling and executing a summarization LLM model, such that the electronic message is input to the summarization LLM model; and
generating the email summary.

6. The method of claim 1, further comprising:
performing the delivery of the email summary by sending a message inbox item with the summary as part of an inbox for display within the inbox.

7. The method of claim 1, wherein the message triaging model performs the analysis of the electronic message based on information selected from: sender identifier (ID), sender domain, content, category of content, type of content, number of recipients, recipient ID, message type, message format, a time, date and a location.

8. The method of claim 1, further comprising the application executing on a device of the recipient.

9. The method of claim 1, further comprising the application executing on a cloud.

10. The method of claim 1, further comprising the application being associated with a mail platform.

11. A system comprising:
a processor configured to:
identify, by an application, an electronic message addressed to an inbox of a recipient;
analyze, by the application executing a messaging triaging model, the electronic message; and
determine, by the application, based on the analysis, whether the electronic message is a triaging candidate, the determination further comprising:
cause delivery of the electronic message to the inbox according to a delivery protocol defined by a message platform hosting the inbox when the application determines the electronic message is not a candidate for triaging, and
cause delivery of at least an email summary of the electronic message to the inbox when the application determines the electronic message is a candidate for triaging.

12. The system of claim 11, such that the processor is further configured to:
call, upon identifying of the electronic message, the message triaging model.

13. The system of claim 11, such that the processor is further configured to:
sample data from a set of electronic messages;
sample data from a set of inboxes;
analyze the sampled data from the set of electronic messages and the sampled data from the set of inboxes; and
perform fine-tuning of the message triaging model based on the analysis of the sampled data.

14. The system of claim 11, such that the processor is further configured to:
extract message information from the electronic message; and
perform model-fine tuning of the message triaging model based on the electronic message and information related to the triaging determination.

15. The system of claim 11, such that the processor is further configured to:
call and execute a summarization LLM model, such that the electronic message is input to the summarization LLM model;
generate the email summary; and
perform the delivery of the email summary by sending a message inbox item with the summary as part of an inbox for display within the inbox.

16. A non-transitory computer-readable storage medium tangibly encoded with computer-executable instructions that when executed by a device, perform a method comprising:
identifying, by an application, an electronic message addressed to an inbox of a recipient;
analyzing, by the application executing a messaging triaging model, the electronic message; and
determining, by the application, based on the analysis, whether the electronic message is a triaging candidate, the determination further comprising:
causing delivery of the electronic message to the inbox according to a delivery protocol defined by a message platform hosting the inbox when the application determines the electronic message is not a candidate for triaging, and
causing delivery of at least an email summary of the electronic message to the inbox when the application determines the electronic message is a candidate for triaging.

17. The non-transitory computer-readable storage medium of claim 16, further comprising:
calling, upon identifying of the electronic message, the message triaging model.

18. The non-transitory computer-readable storage medium of claim 16, further comprising:
sampling data from a set of electronic messages;
sampling data from a set of inboxes;
analyzing the sampled data from the set of electronic messages and the sampled data from the set of inboxes; and
performing fine-tuning of the message triaging model based on the analysis of the sampled data.

19. The non-transitory computer-readable storage medium of claim 16, further comprising:
extracting message information from the electronic message; and
performing model-fine tuning of the message triaging model based on the electronic message and information related to the triaging determination.

20. The non-transitory computer-readable storage medium of claim 16, further comprising:
calling and executing a summarization LLM model, such that the electronic message is input to the summarization LLM model;
generating the email summary; and
performing the delivery of the email summary by sending a message inbox item with the summary as part of an inbox for display within the inbox.
